(19) United States
(12) Patent Application Publication
(10) Pub. No.: US 2008/0139244 A1
(43) Pub. Date: Jun. 12, 2008

(54) Method For Adding Characterization Data During an Image Capture

(76) Inventors: Jean-Marie Vau, Paris (FR); Nicolas P. Touchard, Suresnes (FR); Oliver A. Furon, Dinard (FR)

Correspondence Address: EASTMAN KODAK COMPANY;PATENT LEGAL STAFF, 343 STATE STREET, ROCHESTER, NY, 14650-2201, US

(21) Appl. No.: 10/581,567

(22) PCT Filed: Dec. 3, 2004
(86) PCT No.: PCT/EP2004/013738

§ 371 Date: Jun. 2, 2006

(30) Foreign Application Priority Data
Dec. 18, 2003 (FR) 0315088

(51) Int. Cl. H04N 1/21; H04M 1/00

(52) U.S. Cl. 455/556.1

(57) ABSTRACT

The invention is in the field of digital imaging. The invention relates more specifically to a method for automatically adding and finding characterization data linked to images. The method is implemented in a cellular communications network (1). The method according to the invention is used in a cellular communications network (1), and enables fast, user-friendly and private, management of image characterization data, such as their geolocalization. The invention method comprises the following steps: a) automatically saving, in a mobile terminal (10) comprising a digital image capture means and other digital data linking and saving means capable of communicating with the image capture means, the cell ID (2-N+2) of the network (1) which contains the geographic location (6, 7 & 8) where the capture of at least one image (11) was performed using the mobile terminal (10); b) automatically linking the cell ID containing the geographic location of the image capture (11) with a characterization identifier linked to the image capture entered from the terminal (10), to form a pair of these IDs; c) automatically saving, in the mobile terminal (I O), the ID pair formed in step b).

### FIELD OF THE INVENTION

The invention is in the field of digital imaging. The invention relates more specifically to a method for adding characterization data during an image recording. The method is implemented in a cellular telecommunications network.

### BACKGROUND OF THE INVENTION

The use of communication platforms including radio-controlled telecommunication means and digital image capture and saving means is multiplying. The encouragement to use these platforms to exploit them to the maximum, in a fast and user-friendly way is thus strong. This encouragement is further increased, due to the constant improvement of the memory and display capacities of these platforms.

These platforms or mobile terminals include at the same time telecommunication means, for example telephony, and images capture and saving means. A commonly-used type of digital platform is called a phonecam. A phonecam is a mobile terminal having both a cellular phone function and a video or digital camera function. The working together of these communication and image capture means in particular enables the user to enhance the captured and saved images with multiple data linked to these images. Each digital image saved can thus have its own metadata. Metadata is information contained in a file and specific to an image.

For a digital photograph, for example, the author of the photo and the time it was taken are the metadata contained in its header.

Another important image metadata is the place where this image was captured. This metadata is location data also called “geolocalization” data.

The implementation of geolocalization techniques, for example of the LBST type (Location Based Services Technology) in a communication environment comprising mobile terminals or platforms of the phonecam type, can be technically fairly complex and daunting for the phonecam user. The GPS system (Global Positioning System) enables a precise location to be obtained, but requires the mobile terminal to be equipped with a GPS module, which represents high cost and high energy consumption. Furthermore, geolocalization by this GPS technique works poorly in enclosed places (buildings). The EOTD system (Enhanced Observed Time Difference) uses the signals emitted by mobile phone operators' relays to provide the mobile terminal's geolocalization using a technical triangulation process. In other words, the EOTD system uses the cellular identifier (“CellID”) and cellular area identifier (“AreaID”) information, supplied by mobile phone operators' relays, to determine the terminal's position by the triangulation process. However, this EOTD system requires an agreement with a mobile phone operator to be able to access the geolocalization data. A problem common to both the GPS and EOTD systems is the relating of the geolocalization data (X, Y) to data characterizing the geographic locations that have a meaning for the user (e.g. “at home”, “Peter's house”, etc.). This relating of the data requires a complex database to be kept up-to-date to cross reference these two data types. Indeed, the geolocalization data supplied by the GPS or EOTD systems are generally of the latitude and longitude type. Converting these latitude and longitude data into geographic locations, e.g. of the type “Paris 13^{th} district” or “Arc de Triomphe”, requires these data to be cross referenced in a complex database. Once this conversion has been carried out, these geographic locations (“Paris 13^{th} district” or “Arc de Triomphe”) certainly have a meaning for the user but do not represent familiar and specific locations for this user, as for example “At home”, “Peter's house”, etc.

### SUMMARY OF THE INVENTION

Compared with the prior art, the object of the present invention is to enable a user of a mobile terminal comprising a digital image capture means and also comprising other means for linking and saving digital data, to manage, in a fast, user-friendly and personal or private way, the data or information linked to these images, such as for example image geolocalization data. The management of these data includes in particular the addition of new data specific to an image, and the fact of being able to easily and quickly find images using data characterizing for example an event or a geographic location (geolocalization) linked to these images.

The object of the present invention is to add data, particularly of location (or geolocalization), to images, during the capture and saving of these images from a phonecam type mobile terminal. This operation is executed without going through a network operator, i.e. an access provider.

The object of the present invention is a method for adding characterization data linked to an image, implemented in a cellular telecommunications network. The characterization data linked to an image are specific to each user, and represent for example locations whose naming is familiar and specific to this user (“at home”, “Peter's house”, etc.). The method is implemented in a cellular radiocommunication environment. This means that the communications network is divided up into coverage cells. The cells each cover a geographic area of the network. The geographic area specific to a cell can represent for example, according to the special features of the geographic area in question, coverage that can vary, in area, from a few square meters to several square kilometers. In a city, for example, the cells cover smaller perimeters than outside the urban zone. Generally, two neighboring cells have a common area. Every cell contains a tower or radio relay. The set of cells constitutes a radio network. Within the network organization, the cells are also grouped into cell areas. Each cell area covers a geographic area of the network much greater than the area covered by each of the cells of the cell area. Each coverage cell has an identifier, usually called “CellID”, coded in numerical, alphabetical, or alphanumerical form. This ID is unique for a given cell, and is assigned by the network operator. Similarly, each cell area has a unique ID, usually called “AreaID”, coded in numerical, alphabetical, or alphanumerical form and assigned by the network operator. These two identifiers, “CellID” and “AreaID”, can be accessed from any mobile terminal, without having to make any kind of agreement with the mobile phone operator supplying this identifier data.

The method has several steps that are automatically performed by a program. Based on the capture of one or more images with a digital mobile terminal, camera-telephone or phonecam type, the method consists in automatically saving, in a memory of the mobile terminal, the ID of the network cell that covers the geographic location where the image capture was performed. The ID of the network cell that covers the geographic location where the image capture was performed thus identifies, in coded form, the actual geographic location. The geographic location is defined as a point or area covered by a network cell, i.e. this geographic location is located inside the cell's perimeter. If areas specific to neighboring cells interfere with one another (have a common area), the geographic location can be covered by several of these neighboring cells, if it is located in the area common to these cells. After the image capture, a menu, for example, is proposed to the user on a screen of the phonecam. This menu includes a request asking the mobile terminal user to enter an identifier. This identifier is a characterization identifier linked to the image capture. This characterization identifier linked to the image capture has a number of characters, preferably alphabetical, that are manually entered by the user, using the mobile terminal, and which advantageously provide a characterization of the location of the shot: for is example a house name, street or city name. Or the characterization identifier linked to the image capture is another description, linked for example to an activity: “work”, “conferences”, etc. Then, from the moment when the characterization identifier linked to the image capture is entered, the program automatically enables the ID of the cell containing the geographic location of the image capture to be linked to the characterization identifier linked to the image capture, to form a pair of these identifiers. And the program automatically enables the pair of identifiers thus formed to be saved in a memory of the mobile terminal.

In an advantageous embodiment of the invention, during the capture of several images located in the same cell area, these image captures preferably being performed within a short period of time, for example a few minutes, the method also enables all the cells linked to each of the captured images to be grouped, and the same characterization identifier of the geographic location of capture to be linked to it.

In an advantageous embodiment optimizing the invention, the method also enables, during an image recording, the ID of the cell of the geographic location of the image capture to be automatically compared with all the IDs saved in the mobile terminal. Then, based on this comparison operation, the program enables the ID of the cell of the geographic location of image capture to be automatically linked with the characterization identifier linked to the capture of the corresponding image, if the pair formed by said ID of the cell containing the geographic location of the image capture and said linked characterization identifier is already saved in the recording means. In other words, the method enables the step of manually entering the characterization identifier linked to the image capture to be avoided, provided it was already entered by the user during a previous image capture performed in the same geographic location. This means that over time, the user has less and less manual entering to carry out, because there are more and more IDs of cells containing the geographic locations where the images were captured that are saved in the mobile terminal and linked with the corresponding characterization identifiers to form identifier pairs. Statistically, there is a fairly high probability that over time the user of the terminal will repeat image captures in locations where he/she has already taken one in the past.

In another advantageous embodiment optimizing the invention, the method also enables, during an image capture from a first terminal, the automatic detection of at least one second mobile terminal, located in an environment close to the geographic location of image capture, and then the automatic sending, from the first terminal, of a request to the at least one second nearby terminal. This request enables the ID of the cell containing the geographic location of image capture to be automatically compared with the IDs saved in the second nearby terminal, and depending on the ID pairs saved in the second terminal, the ID of the cell containing the geographic location of image capture to be automatically linked to a characterization ID linked to the capture of said image. This characterization identifier is returned (in response to the request) to the first terminal; this characterization identifier linked to the image capture was already saved in one of these other nearby second terminals. The method then enables the automatic saving of the identifier pair in the first terminal having performed the image capture.

It is also an object of the invention to provide a mobile terminal including a program enabling implementation of the method according to the invention.

Other characteristics and advantages of the invention will appear on reading the following detailed description, with reference to the drawings of the various figures.

### BRIEF DESCRIPTION OF THE DRAWINGS

FIG. 1 schematically shows a cellular telecommunications network representing the invention environment.

FIG. 2 shows a communication platform used to implement the invention method.

### DETAILED DESCRIPTION OF THE INVENTION

The following description is a detailed description of the main embodiments of the invention, with reference to the drawings in which the same numerical references identify the same elements in each of the different figures.

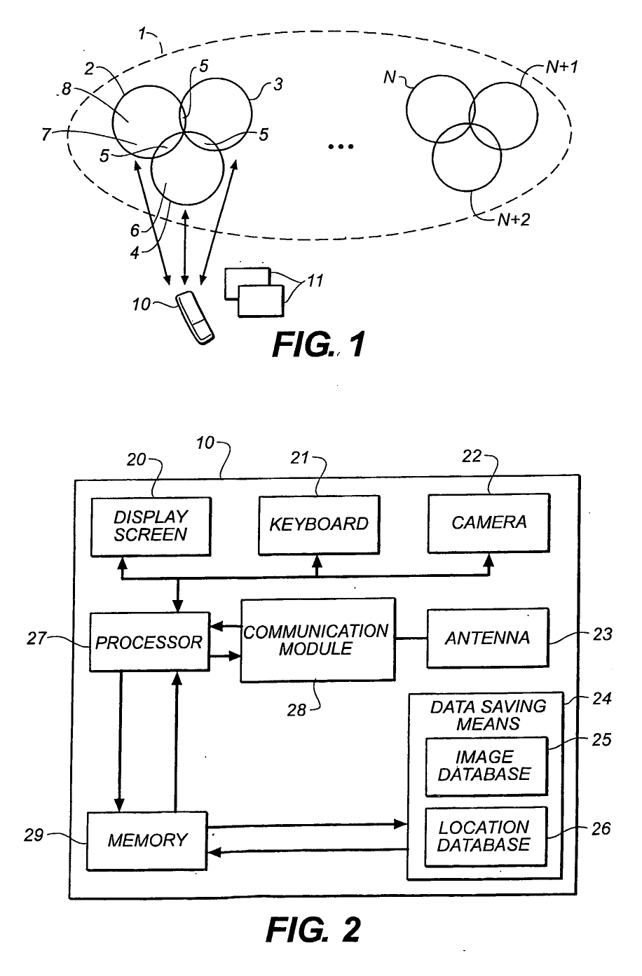

FIG. 1 shows a cellular radiocommunication network 1. This network 1 has (N+1) cells, referenced from 2 to N+2 (or 2-N+2). Each cell contains a communication tower or radio relay. These towers enable a first mobile terminal 10 to communicate, for example with a second terminal of the same type (not shown on the figures) operating in the same network. The second terminal is for example a cellphone. Two neighboring cells 2, 3, 4 have a common area 5 where the signal emitted by each of the cells is sufficiently powerful, i.e. greater than a minimum power enabling reliable communication between the terminal 10 and the tower of each of the cells 2, 3, 4. The surface area of the common area 5 is generally relatively small compared with the total surface area of the area covered by the cell. For example, according to FIG. 1, the neighboring cells 2, 3, 4, have, taken two-by-two, the common area 5. In another embodiment (not shown), one can have a common area 5 in three neighboring cells 2, 3, 4 at the same time. This arrangement of mutual cell coverage enables reliable communication within the network to be ensured. If for example the cell 2 cannot enable correct communication with regard to the terminal 10, the relay is automatically taken up by one of the neighboring cells 3, 4 having a common area 5 with the cell 2. Each operator has its own cell network. Each of these networks, specific to each supplier or operator, covers the same geographic area, for example a city.

To add data, for example geolocalization data, to a digital image, the invention method can be implemented by using a known image metadata format standard, for example EXIF.

One of the purposes of the present invention is to propose a method using other means of geolocalization than the GPS system, to overcome the problems of converting geolocalization data (latitudes, longitudes) into geographic locations data specific to a mobile terminal user. The GPS system enables the position, at any point of the globe, to be given for a mobile terminal equipped with this satellite positioning system.

According to the FIG. 2, and according to a preferred embodiment, the invention is implemented by using a mobile terminal 10 comprising a digital image capture means 22 and other means of digital data management capable of communicating with the capture means 22. The image capture means 22 is preferably a digital camera. The mobile terminal 10 includes digital data management means. These digital data management means include a communication module 28, connected to an antenna 23, acting as interface with the network 1. The communication module 28 is linked to a processor 27. The processor 27 can communicate on the one hand with a display screen 20, a keyboard 21 and the camera 22, and on the other hand with a memory 29. In an advantageous embodiment, the memory 29 can communicate with a data saving means 24 that is a part of the mobile terminal 10. The data saving means 24 comprises an image database 25 and a database of IDs of geographic locations 26. In another embodiment, the saving means 24 is outside the terminal 10; the saving means 24 is for example part of a server (not shown) outside the mobile terminal 10.

One of the objects of the invention is to be able to record in the metadata of a digital image, in an easy, fast, and private way (without being detected by another person), information advantageously linked for example to the geographic location where the image was captured. In this example, the location information is called image “geolocalization”. In other words, the invention method advantageously enables this enhancement of the image data to be executed independently of the network operator with which the mobile terminal 10 operates. That is, the information linked to the image capture is not supplied by the operator.

According to FIG. 1, the invention also advantageously enables the optimization of data, for example of “geolocalization”, linked to an image capture, by using the fact that for the user of the terminal 10 there is on the one hand a limited amount of information specific to the images 11 captured by the user, and on the other hand the fact that over time there is a fairly high probability that the user makes image recordings or savings in the same geographic locations. The geographic location is for example: a location characterizing the place where the user works, a location characterizing the user's place of residence, a friend's place of residence, etc. The work place or place of residence can overlap one or more cells 2-N+2. This means that during a capture of several images 11, in a given location, each image can correspond for example to a different geographic location 6, 7, because each geographic location does not correspond to the same cell 2-N+2. Geographic location 6 corresponds for example to cell 4, and geographic location 7 corresponds to cell 2.

The invention method thus enables the user, from the terminal 10, to capture and record one or more images in a geographic location. The place where the image capture is performed can include one or more geographic locations. These geographic locations 6, 7, 8 can be contained in one or more cells of the network 1. In a first example where the user captures two photos, these two photos can be captured for example in two different geographic locations 7 and 8 placed within the perimeter of a single cell 2, or, in a second example, one of the photos is captured in a geographic location 8 placed within a first cell 2, and the other photo is captured in a geographic location 6 placed within the perimeter of a second cell 4. According to the FIG. 1, these two examples correspond to the case where the two cells 2 and 4 are neighboring. The network operator assigns to each cell 2-N+2 of the network 1 a cell ID. The cell ID generally consists of at least one numerical, alphabetical, or alphanumerical character. Generally and advantageously the cell ID has several numerical characters that thus identify the cell by a number comprising several digits. Preferentially for example the cell ID has five digits. Known location methods of the terminal 10 operating with the network 1, like for example the EOTD process Enhanced Observed Time Difference), enable at any time to automatically assign a cell ID to the terminal 10, according to the geographic situation of the terminal 10 within the perimeter covered by the cells 2-N+2 of the network 1. This ID, depending on the operator, can advantageously be displayed on the terminal's screen 10.

As soon as an image is captured with the terminal 10, the cell ID of the network to which the geographic location belongs where the image capture was performed is advantageously automatically saved in the memory 29 included in the terminal 10.

In an advantageous embodiment optimizing the invention, the method also enables, during the capture of several images located in the same cell area, and preferably within a short period of time, all the cell IDs linked to each of the saved or captured images to be grouped automatically, and only one and the same characterization identifier of the geographic location to be linked to the group. However, if the cell area ID (“AreaID”) changes during the capture of several successive images in the same short period of time, the system does not enable the grouping of the cell IDs linked to each image. In this case, the system asks the user to link a characterization identifier of the geographic location manually for each captured image.

In a first embodiment of the invention method, if the user of the terminal 10 has never recorded, in the past, an image in a geographic location, the method according to the invention enables the user to enter, using the keyboard 21 of the terminal 10, a characterization identifier linked to the image capture that has just been recorded in this geographic location. A menu automatically appears, by flashing for example, on the screen 20 of the terminal 10. This menu includes a request message inviting the user to enter a characterization identifier linked to the image capture. Preferentially, the menu proposes the IDs: for example “my home”, “my work”, “Paris”, “San Francisco”, etc. The user can then, using the keyboard 21, confirm one of the proposed IDs, or enter a new ID whose composition he/she selects. The menu can also enable access to a list of persons or contacts previously saved in the user's mobile terminal. The user can thus choose a contact as characterization identifier of the geographic location (“Peter”, “Mary”, etc.).

When entry of the characterization identifier linked to the image capture is performed, the method according to the invention enables, using the processor 27, the cell ID of the geographic location of the image capture to be linked automatically with the characterization identifier linked with this entry, to form a pair of these IDs; and then the ID pair thus formed is automatically saved into the memory 29.

In a second embodiment of the invention method, if the user of the terminal 10 has already recorded, in the past, at least one image in a geographic location, the method according to the invention enables, during the capture of a new image in this geographic location, the cell ID of the geographic location of this new image capture to be compared automatically with the IDs previously saved in the memory 29 of the mobile terminal 10. Then the cell ID of the geographic location of the image capture is automatically linked with the corresponding characterization identifier linked to this image capture. The linking of IDs is performed if the pair formed by the cell ID of the geographic location of the image recording and the linked characterization identifier is already saved in the memory 29 of the mobile terminal 10. The linking of IDs in pairs is advantageously implemented using an ID linking table. The table of ID pairs is updated using the processor 27. The ID pair data are recorded in the memory 29 of the terminal 10. This second embodiment thus spares the user from reentering a characterization identifier linked to an image capture, if this ID was previously entered and saved. This embodiment highlights an advantage of the invention method: the more the terminal user records images with the terminal 10, the less statistically speaking he/she will have to enter the characterization identifiers linked to these image captures, because in most cases of new image captures, he/she will be in places where he/she has already recorded images in the past. This optimization of the invention method over time, is a particularly interesting advantage that enables the number of manual entries made by the user to be reduced, using the keyboard 21 of the terminal 10.

In a third advantageous embodiment of the invention method, the terminal 10 is equipped with a short-range radio communication module of the Bluetooth or Wi-Fi type (not shown), as part of the communication module 28. During the capture of an image, if the memory 29 of the first terminal 10 does not contain the saving of the cell ID of the geographic location where the image capture is performed, then the method enables the automatic detection, using the short-range radio communication module, of whether at least a second terminal of the same type (not shown on the figures), situated in an environment close to the first terminal 10, possesses the cell ID of the image capture in memory. The nearby environment generally corresponds to a radius of some tens of meters around the first terminal 10. If at least one second terminal is detected, the first terminal 10 enables a request to be sent to the other surrounding terminals present, to determine, by comparison, if at least one of these other surrounding terminals has already saved a pair formed by the cell ID of the geographic location of image capture (by the terminal 10) and a characterization identifier linked to the capture. The first terminal 10 automatically sends a request to the other second surrounding terminals containing the cell ID of the geographic location of the image capture. If at least one of the second terminals already has in memory an ID pair including the cell ID of the geographic location of image capture, the terminal 10 automatically receives a characterization identifier linked to this image capture in reply. In an advantageous embodiment, the user of the terminal 10 can accept or not the characterization identifier sent back. But, if the user of the terminal 10 refuses the characterization identifier sent back, because he/she wishes, for example, to create a new nonexistent characterization identifier, he/she can manually enter the new ID using the keyboard 21 of the terminal 10. This optimization of the invention method among several users of mobile terminals, is a particularly interesting advantage that enables, over time, the number of manual entries of characterization identifier linked to the image captures made by the user to be reduced, using the keyboard 21 of the terminal 10. This optimization enables fast and user-friendly sharing of geolocalization data among several users each equipped with a mobile terminal.

1. A method for adding characterization data linked to an image, using a mobile terminal (10) including a means of digital image capture (22) and other means of linking and saving digital data (24, 27, 28, 29) capable of communicating with the image capture means (22), the method being implemented in a communication network (1) with coverage by cells (2-N+2), a cell ID being automatically linked to each cell, the method comprising the following steps:
a) automatically saving, in the mobile terminal (10), the cell ID (2-N+2) of the network which contains the geographic location (6, 7, 8) where the capture of at least one image (11) was performed using the mobile terminal (10);
b) automatically linking the cell ID containing the geographic location of the image capture (11) with a characterization identifier linked to the image capture entered using the terminal (10), to form a pair of these IDs;
c) automatically saving, in the mobile terminal (10), the ID pair formed in the step b).

2. The method according to claim 1, wherein the forming of the ID pair is performed by automatically linking the respective IDs of at least two cells of a cell area, with a unique characterization identifier linked to the capture of at least one image performed in the at least two cells of the cell area.

3. The method according to claim 1, further comprising, during an image capture, the following steps:
a) automatically comparing the cell ID containing the geographic location of the image capture with the ID pairs saved in the mobile terminal (10);
b) automatically linking the cell ID containing the geographic location of the image capture with the characterization identifier linked to the corresponding image capture, the pair formed by said cell ID containing the geographic location of the image capture and the characterization identifier linked to the image capture being already saved in the mobile terminal (10).

4. The method according to claim 1, also comprising, during an image capture with the first terminal (10), the following steps:
a) automatically detecting at least one second mobile terminal placed in an environment close to the geographic location (6, 7 & 8) where the image capture is performed with the first terminal (10);
b) automatically sending, from the first terminal (10) to the at least one second surrounding mobile terminal detected, a request containing the cell ID containing the geographic location of the image capture;
c) automatically comparing, in each at least one second surrounding terminal, the cell ID containing the geographic location of the image capture received in the request sent by the first terminal (10) with the ID pairs saved in the second terminal;
d) automatically sending to the first terminal (10) the characterization identifier linked to the cell ID containing the geographic location of the image capture received in the request sent by the first terminal (10);
e) automatically linking the cell ID containing the geographic location of the image capture with the characterization identifier linked to the image capture sent to form a pair of these IDs;
f) automatically saving, in the first terminal (10), the ID pair formed in the previous step e).

5. The method according to claim 1, wherein the cell ID containing the geographic location of the image capture includes at least one character formed by a digit or an alphabetical letter.

6. A mobile terminal (10) comprising a digital image capture means (22) and data linking and saving means (24, 27, 28, 29) to implement the method according to any one of claims 1 to 5.
